(19) United States
(12) Patent Application Publication
(10) Pub. No.: US 2020/0242676 A1
(43) Pub. Date: Jul. 30, 2020

(54) SYSTEMS AND METHODS FOR ORDERING CUSTOMIZED PRODUCTS

(71) Applicant: Hall Labs LLC, Provo, UT (US)

(72) Inventors: David R. Hall, Provo, UT (US); Emily Brimhall, Alpine, UT (US)

(73) Assignee: Hall Labs LLC, Provo, UT (US)

(21) Appl. No.: 16/258,838

(22) Filed: Jan. 28, 2019

(51) Int. Cl. G06Q 30/06; E06B 9/24

(52) U.S. Cl. CPC G06Q 30/0621; E06B 2009/2476; E06B 9/24

(57) ABSTRACT

In a first aspect, the invention is a method for ordering custom products, which includes the step of displaying a plurality of styles of customizable products to a user along with a flat rate price for each style. A selection of a style of customizable products and a number of such is received from the user. The cost for the number of customizable products is determined based on the number of customizable products and the flat rate price for the selected style. The customization information for each of the number of customizable is not required to determine the cost. An order is generated to purchase the number of the selected style of customizable products. At some point after the order is generated, the customization information for each of the customizable products in the order is received. A plurality of customized products is provided to fill the order based on the customization information. That plurality of customized products is shipped to the user.

### TECHNICAL FIELD

The present systems and methods are directed to streamlining the ordering process. In particular, the present systems and methods are directed to streamlining the ordering process for ordering customized products.

### BACKGROUND

Online shopping has made the ability to purchase products quick and easy. Unfortunately, not all products lend themselves to quick and easy purchases. For example, customized products, such as window blinds, need to be customized to the size of the window. As a result, in addition to finding the right style at the right price, consumers are burdened with the task of providing detailed measurements so that the correct size of window covering is purchased. Consumers are used to the quick and easy process of online shopping and the additional burden of measuring and/or providing customized information burdens consumers and limits the ability to sell customized products online.

### SUMMARY

In a first aspect, the invention is a method for ordering custom products, which includes the step of displaying a plurality of styles of customizable products to a user along with a flat rate price for each style. A selection of a style of customizable products and a number of such is received from the user. The cost for the number of customizable products is determined based on the number of customizable products and the flat rate price for the selected style. The customization information for each of the number of customizable is not required to determine the cost. An order is generated to purchase the number of the selected style of customizable products. At some point after the order is generated, the customization information for each of the customizable products in the order is received. A plurality of customized products is provided to fill the order based on the customization information. That plurality of customized products is shipped to the user.

In a second aspect, the invention is a method for ordering custom window coverings. The method includes the steps of displaying a plurality of styles of window coverings to a user along with a flat rate price for each style. A selection of a style and a number of a number of windows to be covered is received from the user. The costs is determined based on the number of windows and the flat rate price for the selected style of window covering. The size and customization information for each of the number of windows to be covered is not required to determine the cost. An order is generated to purchase the number of the selected style of window covering at the cost. At some point after the order is generated, the size and customization information for each of the number of windows to be covered is received. At least one window covering of the selected style of window covering is identified to fill the order based on the size and customization information. The at least one window covering is shipped to the user.

In a third aspect, the method includes allocating each of the identified plurality of window coverings to the order.

In a fourth aspect, the selected style represents a plurality of customized window coverings, where each of the customized window coverings is associated with a unique stock keeping unit (SKU).

In a fifth aspect, the purchase price is determined solely by multiplying the flat rate price by the number of windows.

In a sixth aspect, the customization information comprises measurement information, wherein the measurement information includes a height of the window covering and a width of the window covering.

In a seventh aspect, the customization information comprises mounting information, wherein the mounting information includes a type of mount for mounting the window covering to a structure.

In an eighth aspect, the customization information comprises color information, wherein the measurement information includes a color combination of the window covering.

In a ninth aspect, the customization information comprises configuration information, wherein the configuration information includes at least one of a type of window covering control and a location of a window covering control.

In a tenth aspect, the number of windows to be covered with the selected style of window covering is at least two.

In an eleventh aspect, a device for enabling the ordering of custom products is described. The device includes a processor; and memory in electronic communication with the processor, the memory storing instructions that when executed by the processor cause the processor to: display a plurality of styles of window coverings to a user; receive, from the user, a selection of a style of window covering from the plurality of styles of window coverings; request the user to indicate a number of windows to be covered with the selected style of window covering; determine a purchase price for covering the number of windows with the selected style of window covering based solely on the number of windows and a flat rate price for the selected style of window covering, wherein size information or customization information for each window in the number of windows is unknown; generate an order to purchase the selected style of window covering for the indicated number of windows for the purchase price; receive, after the order, customization information for each of the number of windows; identify a plurality of window coverings of the selected style of window covering to use based on the customization information; and ship the plurality of window coverings to the user.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative, and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1, is a flow diagram illustrating of a method for ordering customized products.

FIG. 2 is a block diagram illustrating one example of a first step in a consumer experience for ordering customized products.

FIG. 3 is a block diagram illustrating one example of a second step in a consumer experience for ordering customized products.

FIG. 4 is a block diagram illustrating one example of a third step in a consumer experience for ordering customized products.

FIG. 5, is a flow diagram illustrating of a method for ordering customized products from the perspective of a consumer.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “customizable product” is meant to refer to a product that requires special customization for proper use. For example, home furnishings, such as window coverings (e.g., blinds, shades, etc.) which are customized in multiple ways (e.g., mounting type, width, length, color, control style, charging style, etc.) and selections need to be made from a number of options in order to obtain the desired look and feel (e.g., fit and finish). Other types of home furnishings include products such as floor and furniture covers. It is appreciated that while lots of products require some customization, such as in the case of clothing sizes, as used herein, customized product is meant to refer to products where the burden of customization takes more than a few seconds to complete, and thus becomes a deterrent to the ordering process.

Online shopping has added enormous convenience to the shopping process. The simplicity and ease of being able to browse, add items to a digital shopping cart, then checkout and pay all from the comfort of a couch has completely revolutionized the shopping experience. The ease of the process does result in some drawbacks. For example, while it is easy to add items to a shopping cart, it is also easy to abandon a shopping cart prior to checking out. The loss in sales as a result of shoppers abandoning digital shopping carts is substantial. Accordingly, there is great interest in increasing the purchase rate of digital shopping carts and thus decreasing the amount of abandoned digital shopping carts.

While the rate of abandoned digital shopping carts is sizeable for traditional consumer products, the rate of abandoned digital shopping carts for specialty products (e.g., custom sized products, such as window coverings) is particularly problematic. Often, this is because additional steps are usually needed to order specialty products. For example, in the case of window coverings, a shopper usually need to provide proper measurements for each window so that the correct window covering can be ordered. Such additional steps, such as going through the effort of measuring each of a number of windows in a room or even a number of windows in a home are extremely burdensome. Accordingly, it is no surprise that shoppers who would otherwise be interested in purchasing (as evidenced by placing items in a digital shopping cart, for example), give up turn to other activities (as evidenced by abandoning the digital shopping cart, for example) due to the burden of ordering specialty products. Therefore, there is a need to reduce the burden purchasing specialty products.

The described systems and methods reduce the burden of buying specialty products by placing the checkout process before the customization burden (e.g., measuring) is imposed. In other words, the checkout process is completed before the specific details required to fulfill the order of specialty products (the details necessary for customization, for example) are gathered. It is appreciated that by placing the checkout process before the customization burden is imposed further enables the customization burden to be offloaded to a third party.

It is understood that without the customization details, the cost of fulfilling the order is unknown. That is, simply knowing a style and a number of units ordered does not provide meaningful cost clarity. For example, in the case of window coverings, the cost of covering a small sliding window with a window covering is generally substantially cheaper than the cost of covering a large picture window with a window covering. Therefore, one of the challenges associated with placing the checkout process before collecting the customization details is that the price charged during the checkout process is final, but the actual cost of fulfilling the order is unknown.

It is appreciated that various strategies may be used to select the price charged during the checkout process, but regardless of the strategy employed, there exists a risk that the actual cost of fulfilling the order will exceed the price charged during the checkout process. It is further appreciated, however, that the increase in sales due to the ease of the purchasing process, even for customized products, will greatly outweigh any losses due to exceptional cases. It is anticipated that the price charged during the checkout process will be strategically set so that on average, the described purchasing model approximates traditional pricing models.

The impact of the described systems and methods is a customized product ordering process that is optimized for consumers. Shoppers are enabled to select a preferred style and a required quantity and checkout and purchase before the customization details need to be entered. Thus, the customer can proceed with purchasing without any additional burdens getting in the way of the purchasing process. In the purchasing process, the consumer may be given the option to provide the customization details (and/or to install the specialized product, for example) themselves or to offload the burden to a third party (e.g., a professional measurer/installer). In some cases, the third-party professional measurer/installer may require an additional cost/fee. In other cases, the cost/fee for the third-party professional measurer/installer may be included in the initial purchase price to completely relieve the consumer from any burden associated with the purchase of the specialized product (e.g., customized product, such as window coverings). Thus, the described systems and methods level the playing field between non-customized consumer products and customized products (which typically require measurement information or other customization specific information to complete the order, for example), because the purchase can be easily and quickly online without requiring any additional information (e.g., customization information) until after the purchase is completed.

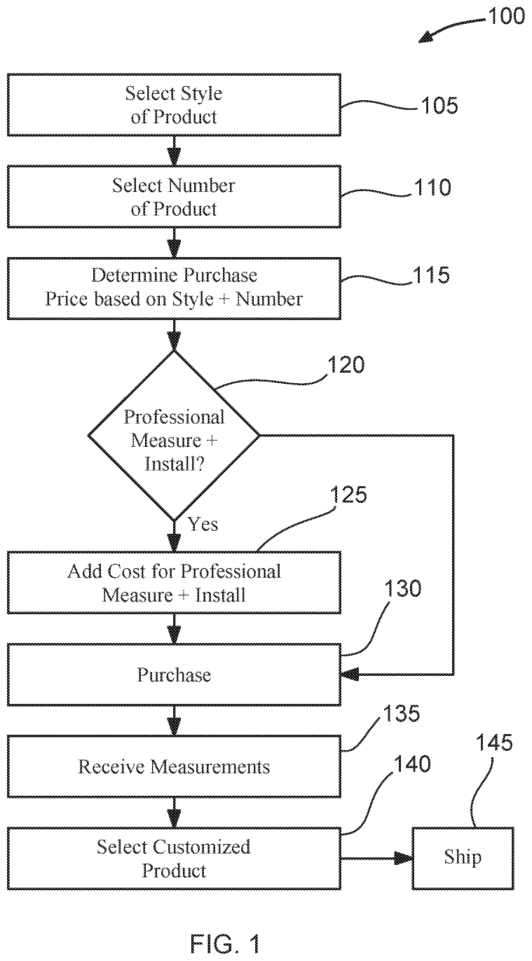

Referring now to the Figures, FIG. 1, is a flow diagram illustrating of a method 100 for ordering customized products. In some embodiments, the method 100 may be implemented by a processor (e.g., a general purpose processor, an application specific processor) such as may be found within a desktop, laptop, tablet, mobile device, server, and the like.

An ecommerce website may be hosted on a server. The ecommerce website may have various interactive features that may be clicked or otherwise interacted with by a consumer so that the consumer may select options and make purchases. Although, the consumer interacts with the ecommerce website, it is understood that each of the steps of method 100 is performed by a processor (of the server, for example).

At 105, the style of a customizable product is selected. For example, the consumer may click on a desired style and the processor may select the style of the customizable product corresponding to the interactive feature selected by the consumer. In some embodiments, the processor may receive a selection of a style (based on input received from the consumer via the ecommerce web site, for example) and may select the style of the customizable product based on the input (e.g., selection) received from the consumer.

In some cases, the style corresponds to a class of customized products. For example, in the case of window coverings, examples of window covering styles may include venetian blinds, mini blinds, micro blinds, panel blinds, pleated shades, cellular shades, roman shades, roller shades, and the like. It is appreciated that within each of these styles are thousands (perhaps tens of thousands, for examples) of different size combinations, color combinations, mounting options, control options, and configurations combinations (location of the twist rod, for example).

At 110, the number of products wanted/needed is selected. For example, the consumer may enter a numerical value or may increase/decrease a quantity value and the processor may select the number of products from the value input/selected by the consumer. In some embodiments, the processor may receive a selection or indication of a desired quantity (based on input received from the consumer via the ecommerce web site, for example) and may select the number of customizable products based on the input (e.g., selection) received from the consumer. In the case of window coverings, the numerical question may be posited to the consumer as “How many windows?” to be covered with the selected style.

At 115, the purchase price is determined based on the price (e.g., established price) for the style and the determined number of products. It is appreciated that the price for the style may not be tied to a specific product price (e.g., price for a specific customized product) but may instead be a strategically selected price to cover for each of the many (e.g., hundreds, thousands, tens of thousands, etc.) customized products (that can be created and can be associated with a unique stock keeping unit (SKU), for example). That is, traditionally, each customized product (that is associated with a unique SKU, for example) is individually priced based on the costs of that particular customized product so that in general, different customized products have different prices (different from each other, for example). In some embodiments, the price for the style may be strategically selected based on a variety of factors including the range of prices of the customized products of a particular style, demand and order volumes of specific products, averages, and the like.

It is noted that the price for the style is not tied to a specific product, but rather is tied to many different customized products (e.g., that may be associated with many different SKUs) that are typically priced individually. It is appreciated that style based pricing may be substantially simpler than having (or managing or calculating) different prices for each of the thousands or tens of thousands of different customized products that fall within the style.

In some embodiments, the styles include features such as whether the window covering is automated or not. The style may also include whether the automated window covering is powered by a solar panel.

At 120, the processor may provide the consumer with the option to have professional measuring and/or professional installation or to do the measuring and/or installation themselves (a do it yourself (DIY) option, for example).

In the case that professional measuring and/or installation is selected, at 125, the cost for professional measure and/or installation is added to the determined purchase price. In the case that professional measuring and/or installation is not selected (e.g., the DIY option), no additional cost is added to the determined purchase price.

In an alternative embodiment, the cost of measuring and/or the cost of installing the window coverings are included in the flat rate price. Preferably, both measuring and installing are included in the flat rate price. Likewise, the shipping costs can be included. In such embodiments, the benefits of an “all in” price are touted to the customer.

At 130, the consumer purchases the quantity of a given style of customized products for the determined cost (e.g., the determined purchase price+additional cost for professional measuring and/or installation or simply the determined purchase price).

At 135, which occurs sometime after the actual purchase (at 130), measurements are received by the processor. For example, the measurements may be received from the professional who did the measuring (when the professional option is used, for example) or the measurements may be received from the consumer (when the DIY option is use, for example).

At 140, the processor selects specific customized products (products associated with a specific SKU, for example) that are the customized solution for fulfilling the order that was purchased at 130. It is appreciated, that it is not until the specific customized products are identified that the actual cost/actual profitability of the purchase at 130 can be determined.

At 145, the processor provides fulfillment information (e.g., creates the shipping level and/or sends instructions for fulfilling the order) for shipping the determined specific customized products to the consumer.

Thus, the described systems and methods enable customizable products, which require additional information, such as measurements and/or installation, to be simply ordered in the same way that typical consumer products are ordered (e.g., browse, select desired product, and purchase). With the describes systems and methods, the purchase price and any other costs (for shipping and/or professional assistance, for example) that are charged at the time of purchase (e.g., 130) are the cost of the purchase, regardless of the actual costs of fulfilling the order associated with the purchase. In other words, the pricing for the consumer is a simple calculation of the price for a given style and a quantity of that style (and any additional costs such as shipping, taxes, and professional service fees, for example).

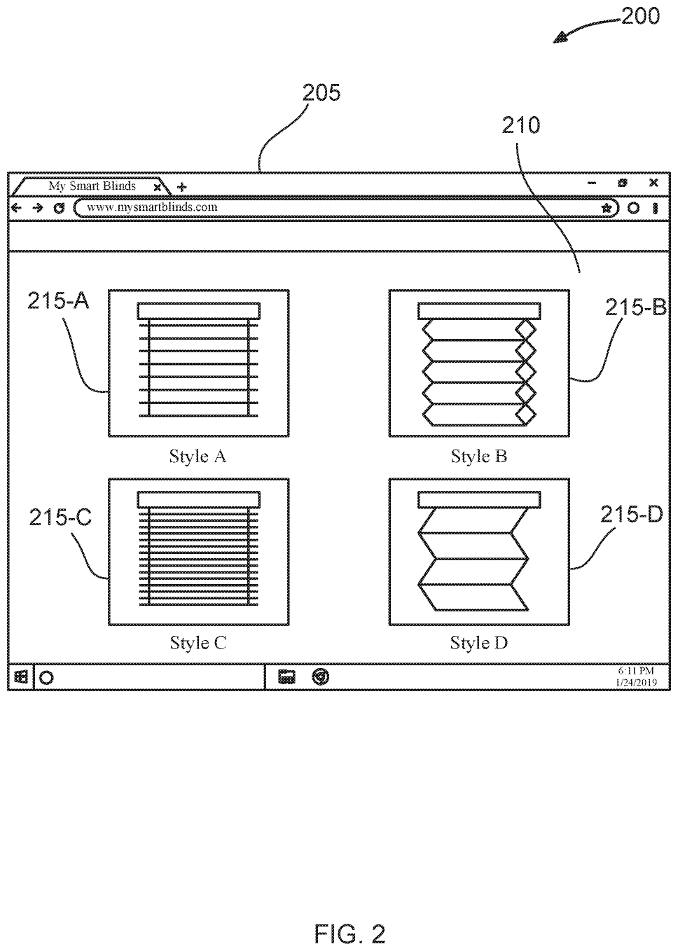

FIG. 2 is a block diagram illustrating one example of a first step in a consumer experience 200 for ordering customized products. The consumer experience 200 includes a display 205 (e.g., screen of an electronic device such as a computer) that is displaying a web browser. The web browser may be presenting an ecommerce site 210 that includes a plurality of product styles. As shown, the ecommerce site 210 illustrates four different styles of window coverings. For example, style A 215-A may be a venetian style of blinds, style B 215-B may be a cellular blind style of blinds, style C 215-C may be a mini blind style of blinds, and style D 215-D may be a roman shades style of blinds. The ecommerce site 210 may be interactive such that a consumer may select a style of blinds to investigate further and/or to purchase.

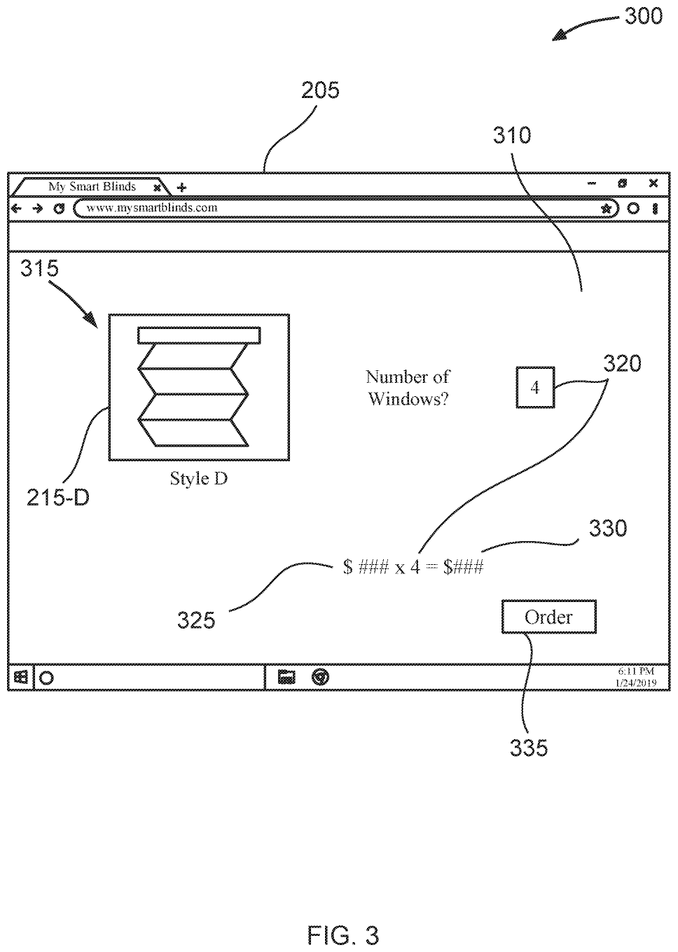

FIG. 3 is a block diagram illustrating one example of a second step in a consumer experience 300 for ordering customized products. The consumer experience 300 includes a display 205 (e.g., screen of an electronic device such as a computer) that is displaying a web browser. The web browser may be presenting an ecommerce site 210 that includes a selected style 315 of products, which in this case is style D 215-D a roman shades style of blinds. The selected style 315 may have a corresponding style price 325 that is displayed to the consumer. In the consumer experience 300 the consumer interacts with the ecommerce site 210 to indicate a desired quantity 320 (e.g., number of products of that style). The desired quantity may be displayed in a mathematical relationship with the price of the style and the resulting value may displayed as the purchase price 335 associated with the given quantity of that style of blinds. With the style and quantity selected the consumer may order instantly (by clicking the order button 335, for example).

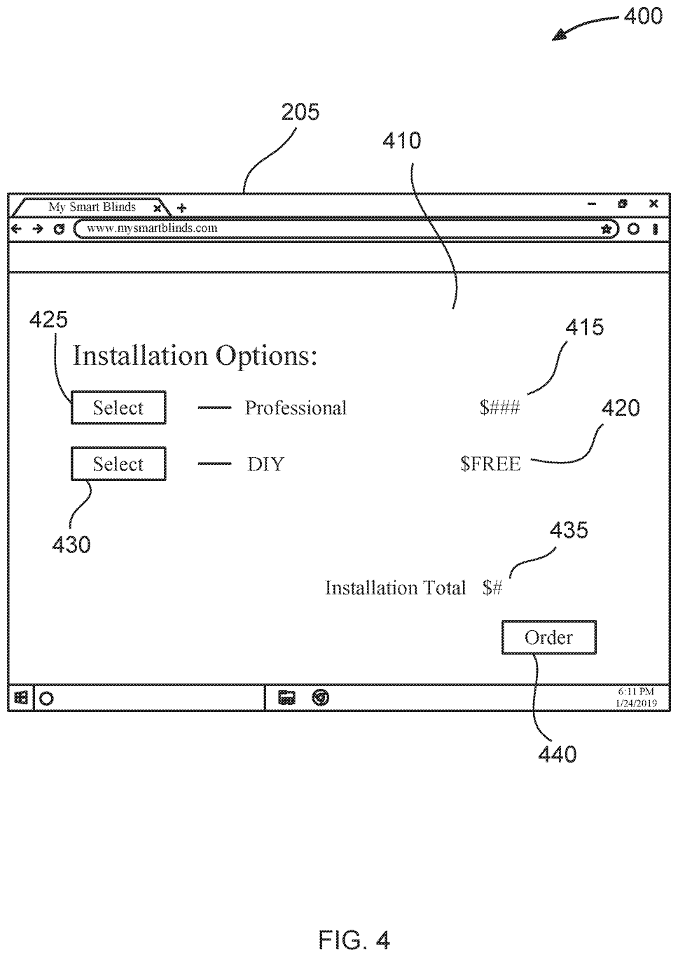

FIG. 4 is a block diagram illustrating one example of a third step in a consumer experience 400 for ordering customized products. The consumer experience 400 includes a display 205 (e.g., screen of an electronic device such as a computer) that is displaying a web browser. The web browser may be presenting an ecommerce site 210 that includes a plurality of product styles. As shown, the ecommerce site 210 illustrates two selectable options, either professional installation (via select button 425, for example) or DIY installation (via select button 430, for example). four different styles of window coverings. The professional installation option may include an additional cost (e.g., professional service fee 415) while the DIY installation option may be a no cost (e.g., free) option (e.g., free option 420). In additional costs may be accumulated as an installation total 435. Once the selection is made (in some cases, the professional option may be the selected option by default, for example) the consumer may order instantly (by clicking the order button 440, for example).

In some cases, the clicking of the order button 440 may make a single purchase that includes both the purchase price and the additional installation costs. In some embodiments, professional installation may be required and may automatically be added to the determined purchase price to result in an all-inclusive total price. In these cases, the ordering is further simplified and the process optimized so that the consumer could select the desired style, the desired number of windows to cover, and the total price would reflect the both the cost of the window coverings and the professional installation, so that the shopping experience is simplified to a single click of the order button and everything happens so that the measurement and installation is handled by third parties.

In other cases, clicking the order button 335 may make a first purchase for the purchase of the product(s) only while clicking the order button 440 may make a second purchase for purchase of the professional services only. In either scenario, the purchase is completed before any measurements or further customization information is provided. As discussed herein, the measurements, identification/selection of the specific customized products needed to fulfill the order, and shipping of the specific customized products are handled behind the scenes, and are not part of the consumer experience.

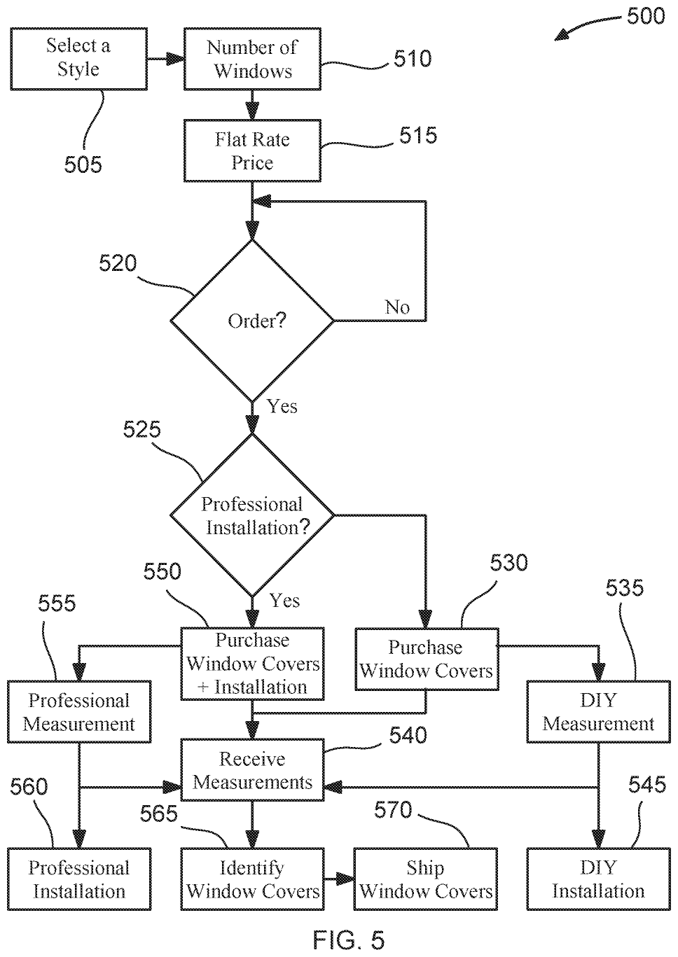

FIG. 5, is a flow diagram illustrating of a method 500 for ordering customized products from the perspective of a consumer. It is appreciated that the method 500 may be enabled by the processor as discussed with respect to method 100.

At 505, a consumer may select a style of window coverings. At 510 the consumer may indicate a number of windows that need to covered with the selected style of window coverings. The flat rate price (e.g., purchase price based on the price for the style and the desired quantity) is provided and the consumer is given the opportunity, at 520, to order the desired quantity of window coverings of the desired style at the flat rate price.

In the case that the consumer needs to make changes, they can adjust the style and or the quantity as desired. In the case that the consumer makes the order, the consumer is presented with the option of professional installation or DIY installation.

In the case that DIY installation is selected, at 530, the purchase is made for the window coverings (although the specific products, remain unknown). On the DIY side, the consumer will handle the DIY measurement task, at 535, and will provide the measurements to the ecommerce site, at 540, which will receive the measurements.

In the case that professional installation is selected, at 550, the purchase is made for the window coverings (although the specific products, remain unknown) plus any additional cost for the professional services. On the professional installation side, a professional will schedule a time and will handle the measurement task, at 555, and will similarly provide the measurements to the company (via the ecommerce site, for example), at 540, which will receive the measurements.

Once the measurements (e.g., customization information) are received, the specific window coverings needed to fulfill the order (i.e., the specific customized products needed to fit the customized sizes and specifications as indicated in the received measurement information) are identified, at 565. At 570, the identified/selected window coverings are shipped (to the consumer, for example) so that they can be installed either by the consumer as a DIY installation, at 545, or by the professional as a professional installation, at 565.

The specific customized products that are shipped for installation are allocated in the accounting system to the order that was made so that actual cost of goods sold as compared to the purchase price may be determined for profitability and margin analysis as well as for managing any inquiries into the transaction.

Thus, the systems and methods described herein completely remove any burdens associated with ordering customized products, so as to streamline the purchasing process, and enables the burdens to be completely offloaded to a third-party (e.g., a professional).

The invention has been described with reference to various specific and preferred embodiments and techniques. Nevertheless, it is understood that many variations and modifications may be made while remaining within the spirit and scope of the invention.

What is claimed is:

1. A method for ordering custom products, comprising:
displaying a plurality of styles of customizable products to a user along with a flat rate price for each style;
receiving, from the user, a selection of a style of customizable products;
receiving from the user a number of customizable products;
determining a cost for the number of customizable products based on the number of customizable products and the flat rate price for the selected style, wherein customization information for each of the number of customizable is not required to determine the cost;
generating an order to purchase the number of the selected style of customizable products;
receiving, at some point after the order is generated, the customization information for each of the customizable products in the order;
providing a plurality of customized products to fill the order based on the customization information; and
shipping the plurality of customized products to the user.

2. The method of claim 1 wherein the customization information includes size information.

3. The method of claim 1 wherein the customizable product is a home furnishing.

4. A method for ordering custom window coverings, comprising:
displaying a plurality of styles of window coverings to a user along with a flat rate price for each style;
receiving, from the user, a selection of a style of window covering from the plurality of styles of window coverings;
receiving from the user a number of windows to be covered with the selected style of window covering;
determining a cost for covering the number of windows with the selected style of window covering based on the number of windows and the flat rate price for the selected style of window covering, wherein size and customization information for each of the number of windows to be covered is not required to determine the cost;
generating an order to purchase the number of the selected style of window covering at the cost;
receiving, at some point after the order is generated, the size and customization information for each of the number of windows to be covered;
identifying at least one window covering of the selected style of window covering to fill the order based on the size and customization information; and
shipping the at least one window covering to the user.

5. The method of claim 4, further comprising:
allocating each of the identified plurality of window coverings to the order.

6. The method of claim 4, wherein the cost is determined solely by multiplying the flat rate price of the selected style and the number of the number of windows to be covered.

7. The method of claim 4, wherein the selected style represents a plurality of customized window coverings, where each of the customized window coverings is associated with a unique stock keeping unit (SKU).

8. The method of claim 4 wherein the flat rate price includes a cost of measuring and a cost installing the window coverings.

9. The method of claim 4 wherein a cost of measuring and a cost of installing the window coverings are displayed to separately from the flat rate price.

10. The method of claim 4 wherein the plurality of styles includes automated and non-automated window coverings.

11. The method of claim 9 wherein the plurality of styles includes automated window coverings powered by solar panels.

12. The method of claim 4, wherein the size and customization information comprises a height of the window covering and a width of the window covering.

13. The method of claim 4, wherein the size and customization information comprises mounting information, wherein the mounting information includes a type of mount for mounting the window covering.

14. The method of claim 4, wherein the customization information comprises configuration information, wherein the configuration information includes at least one of a type of window covering control and a location of the window covering control.

15. A device for enabling the ordering of custom window coverings, comprising:
a processor;
memory in electronic communication with the processor, the memory storing instructions that when executed by the processor cause the processor to:
display a plurality of styles of window coverings to a user along with a flat rate price for each style;
receive, from the user, a selection of a style of window covering from the plurality of styles of window coverings;
receive from the user a number of windows to be covered with the selected style of window covering;
determine a cost for covering the number of windows with the selected style of window covering based on the number of windows and the flat rate price for the selected style of window covering, wherein size and customization information for each of the number of windows to be covered is not required to determine the cost;
generate an order to purchase the number of the selected style of window covering at the cost;
receive, at some point after the order is generated, the size and customization information for each of the number of windows to be covered;
identify at least one window covering of the selected style of window covering to fill the order based on the size and customization information; and
ship the at least one window coverings to the user.

16. The device of claim 15, wherein the instructions are further executable by the processor to:
allocate each of the identified plurality of window coverings to the order.

17. The device of claim 15, wherein the cost is determined solely by multiplying the flat rate price of the selected style and the number of the number of windows to be covered.

18. The device of claim 15, wherein the size and customization information comprises a height of the window covering and a width of the window covering.

19. The device of claim 15, wherein the size and customization information comprises mounting information, wherein the mounting information includes a type of mount for mounting the window covering to a structure.

20. The device of claim 15, wherein the size and customization information comprises configuration information, wherein the configuration information includes at least one of a type of window covering control and a location of a window covering control.
